(19) United States
(12) Patent Application Publication
(10) Pub. No.: US 2014/0178647 A1
(43) Pub. Date: Jun. 26, 2014

(54) WINDOW GLASS HAVING INLAY PRINTING PART IN BEZEL AREA AND METHOD FOR MANUFACTURING THE SAME

(71) Applicant: SAMSUNG ELECTRO-MECHANICS CO., LTD., Suwon (KR)

(72) Inventors: Young Jae Kim, Suwon (KR); Ho Joon Park, Suwon (KR); Seung Joo Shin, Suwon (KR); Ha Yoon Song, Suwon (KR)

(21) Appl. No.: 13/913,027

(22) Filed: Jun. 7, 2013

(30) Foreign Application Priority Data
Dec. 24, 2012 (KR) 10-2012-0152394

(51) Int. Cl. G06F 1/16; B44F 7/00; B44C 5/04; B32B 3/30

(52) U.S. Cl. CPC G06F 1/1633; B32B 3/30; B44F 7/00; B44C 5/0407
USPC 428/166; 216/24

(57) ABSTRACT

Disclosed herein are a window glass having an inlay printing part in a bezel area and a method for manufacturing the same. The window glass includes: a glass body providing a display surface in a touch screen module and having a trench intaglio-formed in an inactive area of an edge part of an inner surface thereof; the inlay printing part made of an ink displayed to a front surface of the glass body in a state in which the ink is filled in the trench; and a bezel area laminated in the inactive area in a state in which it covers the inlay printing part.

### CROSS REFERENCE TO RELATED APPLICATION

This application claims the benefit of Korean Patent Application No. 10-2012-0152394, filed on Dec. 24, 2012, entitled “Window Glass Having Inlay Printing Part in Bezel Part and Method for Manufacturing the Same”, which is hereby incorporated by reference in its entirety into this application.

### BACKGROUND OF THE INVENTION

1. Technical Field

The present invention relates to a window glass having an inlay printing part in a bezel part and a method for manufacturing the same.

2. Description of the Related Art

A touch screen panel is installed on a display surface of a flat panel display apparatus such as a liquid crystal display (LCD), a plasma display panel (PDP), an organic light emitting diode (OLED), or the like, to allow a user to input desired information while viewing the touch screen panel.

The touch screen panel may be divided into a resistive type touch screen panel, a capacitive type touch screen panel, an ultrasonic type touch screen panel, an infrared type touch screen panel, and the like.

The resistive type touch screen panel has a form in which resistance component materials are coated on a pair of glasses or transparent plastic plates, respectively, and a polyester film is covered thereon, has a structure in which two surfaces are spaced apart from each other by a predetermined interval using a spacer so as not to contact each other, and recognizes a position of a touched hand by a change degree of voltage when a substrate is pressed.

In addition, the ultrasonic type touch panel has a configuration in which a transmitter emitting a sound wave is attached to an edge of one side of a glass substrate and a reflector reflecting the sound wave is mounted at the other side and has a principle of calculating a point in time at which an object such as a finger obstructing the sound wave obstructs a movement path of the sound wave to recognize a touch point.

In the infrared type touch panel, which uses straightness of an infrared ray, an infrared light emitting diode (LED), which is a light emitting device, and a phototransistor, which is a light receiving device, are disposed to face each other to configure a matrix, and a sensor senses a point at which light is blocked by an object such as a finger in the matrix to recognize a touch point.

In addition, the capacitive type touch screen panel has a structure of recognizing a touch point by analyzing a high frequency waveform changed at the time of a touch by a finger in a state in which transparent special conductive metals are coated on both surfaces of a glass substrate and voltage is applied to four edges of a touch screen to allow a high frequency to be generated on a surface of the touch screen.

Meanwhile, a logo, a firm name, or the like, for discriminating a product to which the touch screen panel is applied is printed in a bezel area of the touch screen panel. The printed part such as the logo, the firm name, or the like, as described above is formed on an inner surface of a window glass in a screen printing method or a depositing method and a bezel layer is formed thereon.

In connection with formation of the printing part as described above, Korean Patent No. 10-1125701 (entitled ‘Touch Panel and Method for Manufacturing the Same’) has disclosed a feature of depositing a logo printing part on a cover glass. The logo printing part, which is formed by a vacuum depositing method using a shadow mask instead of an existing general printing method, has a feature in which a thickness step thereof is several hundred nanometers or less.

Since all existing logo printing parts as well as the logo printing part disclosed in the above-mentioned patent are laminated on a surface of the cover glass, they have a two-dimensional structure, such that they do not implement a feeling to some degree or more. For example, discrimination such as a three-dimensional stereoscopic feeling, texture, or the like, may not be produced.

### SUMMARY OF THE INVENTION

The present invention has been made in an effort to provide a window glass having an inlay printing part in a bezel part capable of producing a three-dimensional stereoscopic feeling by forming a trench having a shape of a desired pattern, figure, or letter in the window glass and filling an ink in the trench to the inlay printing part, and a method for manufacturing the same.

According to a preferred embodiment of the present invention, there is provided a window glass having an inlay printing part in a bezel part, including: a glass body providing a display surface in a touch screen module and having a trench intaglio-formed in an inactive area of an edge part of an inner surface thereof; and the inlay printing part made of an ink displayed to the outside of the glass body in a state in which the ink is filled in the trench and covered by the bezel part.

The trench may have a shape of a letter or a figure.

The ink filled in the trench may have one or more color.

The ink may be a light non-transmitting ink.

The trench may include a plurality of visibility enlarging grooves formed therein.

According to another preferred embodiment of the present invention, there is provided a method for manufacturing a window glass, including: a lamination step of laminating a resist layer on an inside surface of the window glass having a predetermined thickness; an exposure and development step of exposing and developing the resist layer to form an exposed surface having a desired letter or figure in a zone at which a bezel part of the window glass is to be formed; a trench forming step of etching the exposed surface of the window glass to form a trench having the letter or the figure in the window glass; an ink filling step of filling an ink in the trench formed by the trench forming step; and a bezel part forming step of forming a bezel layer in the zone at which the bezel part is to be formed after the ink filled in the trench is cured.

The etching performed in the trench forming step may be dry etching using a sand blaster and wet etching using hydrofluoric acid.

The ink filling step may be a process performed by a screen printing process.

The bezel part forming step may be a step of laminating a black bezel ink in the zone at which the bezel part is to be formed by the screen printing process.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a cellular phone to which a window glass having an inlay printing part in a bezel area according to a preferred embodiment of the present invention is applied;

FIG. 2 is a cross-sectional view for describing a structure of the window glass having an inlay printing part in a bezel area according to the preferred embodiment of the present invention;

FIG. 3 is a partial cross-sectional view showing an implementation of the inlay printing part shown in FIG. 2;

FIG. 4 is a partial cross-sectional view showing another implementation of the inlay printing part shown in FIG. 2;

FIG. 5 is a partial cross-sectional view showing still another implementation of the inlay printing part shown in FIG. 2;

FIG. 6 is a cross-sectional view for describing a method for manufacturing a window glass having an inlay printing part in a bezel area according to a preferred embodiment of the present invention; and

FIG. 7 is a block diagram showing a method for manufacturing a window glass according to a preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings,

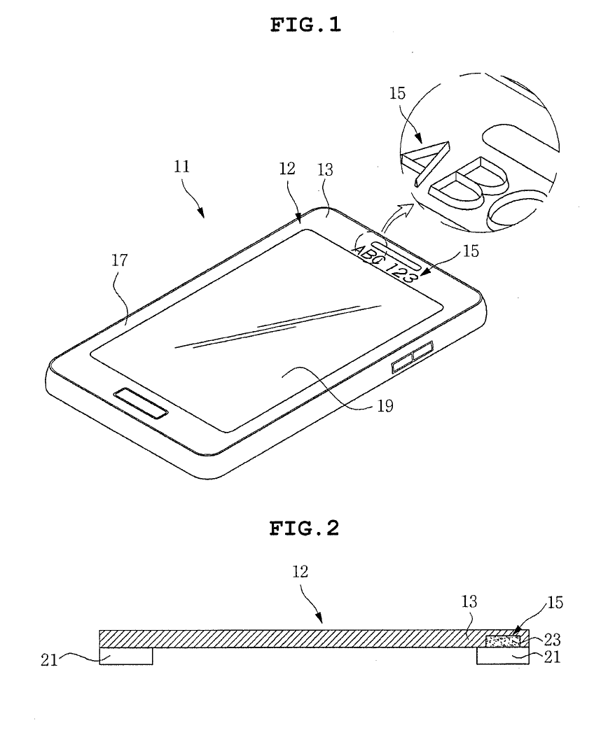

FIG. 1 is a perspective view of a cellular phone to which a window glass having an inlay printing part in a bezel area according to a preferred embodiment of the present invention is applied.

Basically, in the preferred embodiment of the present invention, a three-dimensional inlay printing part 15 is intaglio-formed in a bezel area 17 of a window glass, which is a front surface of a portable terminal, thereby making it possible to accomplish advancement and discrimination of a product.

Referring to FIG. 1, it may be appreciated that the window glass 12 is disposed on the front surface of the cellular phone 11 and the inlay printing part 15 is formed at one side of the bezel area 17 of the window glass 12.

The window glass 12 is divided into a touch area 19 and the bezel area 17. The touch area 19, which is an input/output part of the cellular phone 11, may be an active area on which a user inputs his/her desired contents or input contents are output. In addition, the bezel area 17, which is an inactive area at which a wiring, or the like, for driving a touch screen module is positioned, is formed at an edge part of the window glass 12.

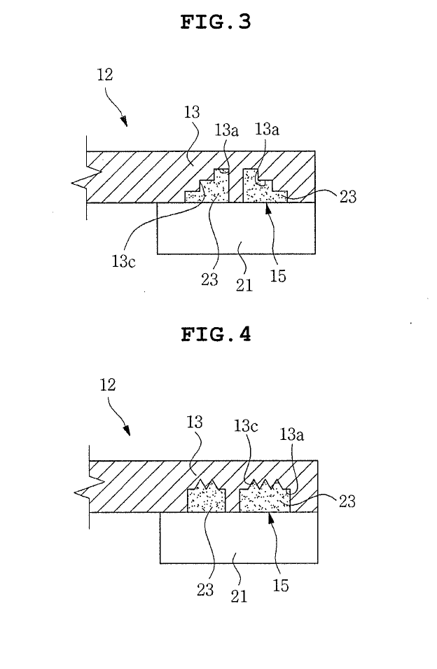

The window glass 12 according to the present embodiment, which is a light-transmitting glass having a predetermined thickness, is configured to include a glass body 13 having a trench 13a (See FIGS. 3 to 5) intaglio-formed in an inactive area (a zone at which the bezel area is to be formed) of an edge part of an inner surface thereof (an inside surface toward a wiring circuit) and the inlay printing part 15 including an ink 23 displayed to the outside in a state in which the ink is filled in the trench 13a and covered by the bezel layer 21.

As shown in FIG. 1, the inlay printing part 15 positioned at an inner side of the bezel area 17, which is a part disposed by the ink filled in the trench 13a, has a three-dimensional stereoscopic feeling.

Particularly, although the inlay printing part 15 is formed only at one bezel area 17 in FIG. 1, it may also be formed at other bezel area. In addition, various geometrical patterns, cartoon characters, or the like, in addition to a letter or a numeral may be applied as the inlay printing part 15.

FIG. 2 is a cross-sectional view for describing a structure of the window glass 12 having an inlay printing part in a bezel area according to the preferred embodiment of the present invention.

As shown in FIG. 2, the inlay printing part 15 is disposed at an edge part of a rear surface of the glass body 13. The inlay printing part 15 is a part formed by forming the trench in the inactive area of the rear surface of the glass body 13, filling the ink 23 in the trench, and curing the ink 23 and then covered by the bezel layer 21.

The ink 23 filled in the inlet printing part 15 may have a single color or several colors. Since the ink 23 is filled in an internal space of the trench, a shape of the trench is displayed to the outside through the ink.

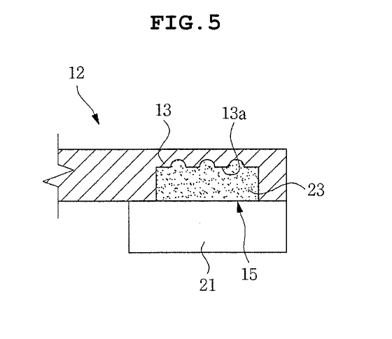

FIG. 3 is a partial cross-sectional view showing an implementation of the inlay printing part shown in FIG. 2; FIG. 4 is a partial cross-sectional view showing another implementation of the inlay printing part shown in FIG. 2; and FIG. 5 is a partial cross-sectional view showing still another implementation of the inlay printing part shown in FIG. 2.

Referring to FIGS. 3 to 5, it may be appreciated that various types of trenches 13a are formed in the glass body 13. The trench 13a is formed by an etching process to be described below. A shape of the trench may be variously changed by an etching method, and the trenches 13a of FIGS. 3 to 5 are examples of trenches implemented by the etching method.

In any case, an inner portion of the trench 13a is filled with the ink 23. Colors and individual characteristics of the ink may be variously changed and applied. For example, a fluorescent material may also be mixed with the ink.

A reference numeral 13c indicates a visibility enlarging groove. The visibility enlarging groove 13c corresponding to a groove in which an acute edge (sharp portion) is formed is processed together with the trench 13a when the trench 13a is formed. As described above, the ink filled in the visibility enlarging groove 13c is differently viewed according to an angle at which it is viewed from the outside.

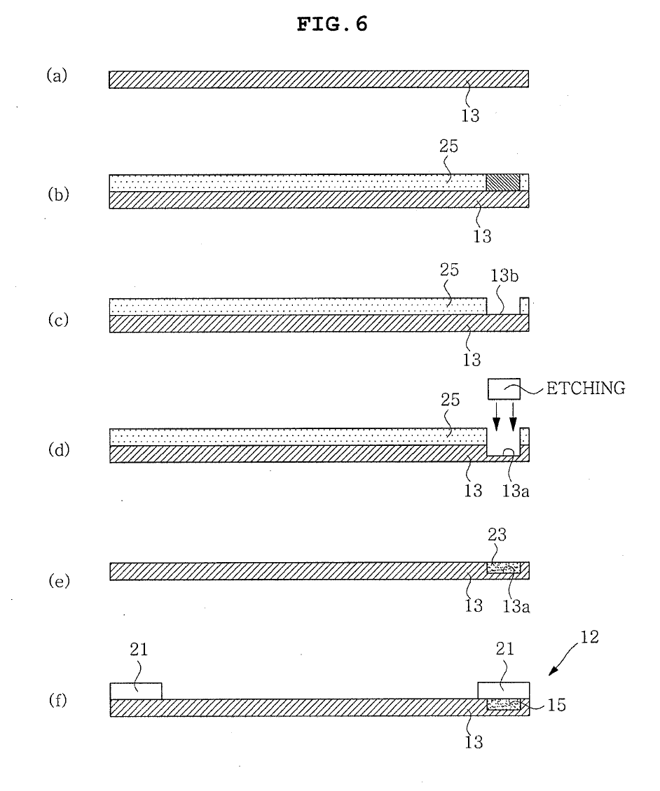

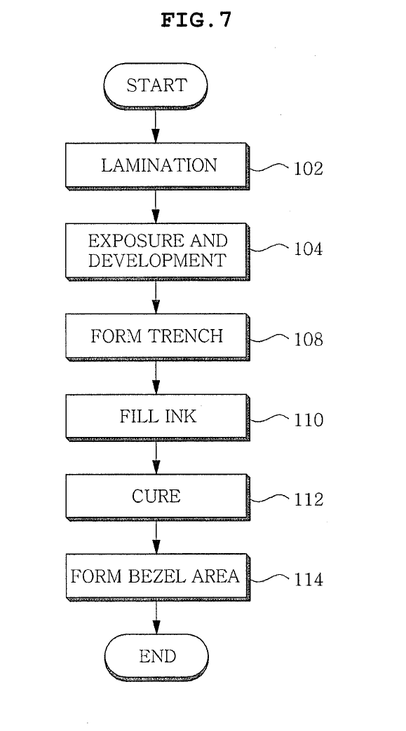

FIG. 6 is a cross-sectional view for describing a method for manufacturing a window glass 12 having an inlay printing part in a bezel area according to a preferred embodiment of the present invention; and FIG. 7 is a block diagram showing a method for manufacturing a window glass according to a preferred embodiment of the present invention.

Terms “upper portion” and “lower portion” used in the following description may be based on a state shown in the accompanying drawings.

In order to manufacture the window glass 12 having the inlay printing part 15 according to the present embodiment, a rectangular glass body 13 (FIG. 6A) having a predetermined thickness is first prepared. The glass body 13 is also a base having an indium tin oxide (ITO) layer, an electrical wiring, and the like, to be laminated on an upper surface thereof (in the accompanying drawings).

After the glass body 13 is prepared, a lamination step (102) of laminating a dry film resist 25 on an inside surface of the glass body 13, that is, an upper surface in the accompanying drawings is performed.

When the lamination step (102) is completed, an exposure and development step (104) is performed. The exposure and development step 104 is a step of exposing and developing the dry film resist in a state in which a mask (not shown) is positioned on the dry film resist to form an exposed surface 13b having a shape of a desired letter, figure, pattern, or character. To this end, a hole having the shape of the letter, figure, pattern, or character should be formed in the mask.

After a two-dimensional exposed surface 13b having a desired shape is obtained by the above-mentioned process, a trench forming step (108) is performed. The trench forming step (108) is a process of etching the exposed surface 13b to form a trench 13a, which is a three-dimensional groove, in the glass substrate 13.

As the etching method, various etching methods may be used. For example, a dry etching method using a sand blaster and a wet etching method using hydrofluoric acid may be used.

After the trench 13a is formed at an edge part of the glass body 13 by the trench forming step (108), an ink filling step (110) is performed. The ink filling step (110) is a process of filling a desired color or kind of ink 23 in an internal space in the formed trench 13 to form a three-dimensional inlay printing part 15.

As a method of filling the ink 23 in the trench 13 described above, a screen printing method may be used. The ink filled in the trench 13 displays the letter, the figure, the character, or the like, to the outside, but is not protruded upwardly of the glass substrate 13.

Even though an existing logo printing part is thinly deposited, it has a physical thickness to cause a step problem. However, the inlay printing part according to the preferred embodiment of the present invention does not have a thickness, thereby making it possible to allow the window glass 12 to be manufactured at a more thin thickness.

Then, a curing step (112) is performed. The curing step 112 is a process of curing the ink filled in the trench 13a at its position. A method for curing the ink may be changed according to a kind of ink.

After the curing step 112 is finished, a bezel area forming step (114) is performed. The bezel part forming step (114) is a process of laminating a black bezel ink in a zone at which the bezel area is to be formed by a screen printing method to form the bezel layer 21. The trench 13a is completely sealed by the bezel layer 21.

The window glass 12 in which the bezel area 17 is laminated by the bezel area forming step (114) is obtained.

With the window glass having an inlay printing part in a bezel part and the method for manufacturing the same according to the preferred embodiments of the present invention configured as described above, the trench having the shape of the desired pattern, figure, or letter is formed in the window glass and an inner portion thereof is filled with the ink to form the inlay printing part, thereby making it possible to produce a three-dimensional stereoscopic feeling.

Although the embodiment of the present invention has been disclosed for illustrative purposes, it will be appreciated that to the present invention is not limited thereto, and those skilled in the art will appreciate that various modifications, additions and substitutions are possible, without departing from the scope and spirit of the invention.

Particularly, the inlay printing part may be formed at any position of the bezel area. That is, the inlay printing part may be formed at all of upper and lower portions and both sides of the bezel area forming a rectangular edge part or be selectively formed.

Accordingly, any and all modifications, variations or equivalent arrangements should be considered to be within the scope of the invention, and the detailed scope of the invention will be disclosed by the accompanying claims.

What is claimed is:

1. A window glass having an inlay printing part in a bezel area, comprising:
a glass body providing a display surface in a touch screen module and having a trench intaglio-formed in an inactive area of an edge part of an inner surface thereof; and
the inlay printing part made of an ink displayed to the outside of the glass body in a state in which the ink is filled in the trench and covered by the bezel layer,

2. The window glass as set forth in claim 1, wherein the trench has a shape of a letter or a figure.

3. The window glass as set forth in claim 1, wherein the ink filled in the trench has one or more color.

4. The window glass as set forth in claim 2, wherein the ink filled in the trench has one or more color.

5. The window glass as set forth in claim 3, wherein the ink is a light non-transmitting ink.

6. The window glass as set forth in claim 4, wherein the ink is a light non-transmitting ink.

7. The window glass as set forth in claim 1, wherein the trench includes a plurality of visibility enlarging grooves formed therein.

8. A method for manufacturing a window glass, comprising:
a lamination step of laminating a resist layer on an inside surface of the window glass having a predetermined thickness;
an exposure and development step of exposing and developing the resist layer to form an exposed surface having a desired letter or figure in a zone at which a bezel area of the window glass is to be formed;
a trench forming step of etching the exposed surface of the window glass to form a trench having the letter or the figure in the window glass;
an ink filling step of filling an ink in the trench formed by the trench forming step; and
a bezel area forming step of forming a bezel layer in the zone at which the area part is to be formed after the ink filled in the trench is cured.

9. The method as set forth in claim 8, wherein the etching performed in the trench forming step is dry etching using a sand blaster or wet etching using hydrofluoric acid.

10. The method as set forth in claim 8, wherein the ink filling step is a process performed by a screen printing process.

11. The method as set forth in claim 8, wherein the bezel area forming step is a step of laminating a black bezel ink in the zone at which the bezel area is to be formed by the screen printing process.
